(19) United States
(12) Patent Application Publication
(10) Pub. No.: US 2014/0080712 A1
(43) Pub. Date: Mar. 20, 2014

(54) COMPOSITIONS AND METHODS FOR DOUBLE ENCAPSULATION OF A VOLATILE COMPOUND

(71) Applicant: AgroFresh Inc., Spring House, PA (US)

(72) Inventors: Christine Lihong Lao, Shanghai (CN); Shiling Zhang, Shanghai (CN); Christian Guy Becker, King of Prussia, PA (US); Taylor Xiao Yi Pang, Shanghai (CN); Tong Sun, Shanghai (CN); Xiuhan Grace Yang, Shanghai (CN)

(21) Appl. No.: 14/029,466

(22) Filed: Sep. 17, 2013

Related U.S. Application Data
(63) Continuation-in-part of application No. PCT/CN2012/081468, filed on Sep. 17, 2012.
Application No. PCT/CN2012/081468 is a continuation-in-part of application No. PCT/CN2013/071362, filed on Feb. 5, 2013.
(60) Provisional application No. 61/713,924, filed on Oct. 15, 2012.
(60) Provisional application No. 61/792,300, filed on Mar. 15, 2013.

(51) Int. Cl. A01N 25/26; A01N 27/00

(52) U.S. Cl. CPC A01N 25/26; A01N 27/00
USPC 504/357

(57) ABSTRACT

The present invention relates to compositions, methods and materials for delivering a cyclopropene or other active ingredient to a plant. Provided are compositions comprising double encapsulated particles having a waxy coating and being imbedded in a resin matrix. Such double encapsulated particles are further coated with Pickering particles and suspended in an oil. The double encapsulated particles comprise a volatile compound (for example, 1-MCP complex powder) as an active ingredient. Also provided are methods for preparing such compositions and methods for using such compositions.

### BACKGROUND

Ethylene is an important regulator for the growth, development, senescence, and environmental stress of plants, mainly affecting related processes of plant ripening, flower senescence and leaf abscission. Ethylene is usually generated in large amounts during growth of plants under environmental stress or during preservation and delivery of plants. Therefore yield of plants such as fruit and crop can be reduced under heat or drought stress before harvesting. The commercial value of fresh plants such as vegetables, fruits and flowers after harvesting is reduced by excessive ethylene gas which hastens the ripening of fruits, the senescence of flowers and the early abscission of leaves.

To prevent the adverse effects of ethylene, 1-methylcyclopropene (1-MCP) is used to occupy ethylene receptors and therefore inhibiting ethylene from binding and eliciting action. The affinity of 1-MCP for the receptor is approximately 10 times greater than that of ethylene for the receptor. 1-MCP also influences biosynthesis in some species through feedback inhibition. Thus, 1-MCP is widely used for fresh retention post-harvest and plant protection pre-harvest.

But 1-MCP is difficult to handle because it is gas with high chemical activity. To address this problem, 1-MCP gas has been encapsulated successfully by oil-in-water emulsion with 1-MCP gas dissolved in internal oil phase, but 1-MCP concentration in final product is still low (<50 ppm).

In another manner of addressing this problem, which is used in current agricultural applications, 1-MCP is complexed with cyclodextrin to form a powder. 1-MCP can be released from the complex as a gas when the powder is dissolved in water. A powder product is much more convenient to use than a product in gas form, but the powder still has disadvantages including: (1) it is not user-friendly when handling powder in the field or in an enclosed space; (2) the powder form cannot stably and uniformly be suspended in water, which leads to non-uniform delivery of 1-MCP to plants and uneven ripening response of plants; and (3) after contact with water, 1-MCP is released completely within a short period of time, which is much earlier than desired in many applications, causing some or all of the 1-MCP to be lost to the surroundings. Therefore, 1-MCP powder products are not properly formulated for use in water that is suitable for delaying plant maturation in the field.

One effort to solve the above problems includes mixing 1-MCP complex powder with other powders to form solid material mixtures, then processing the mixture into the form of effervescent tablets or enclosing the mixture in a water impermeable container. But such modified compositions still have disadvantages including: (1) similar to the limitations of powders, they are still limited in applications since they usually require air circulation to ensure uniform distribution of 1-MCP, which is not available in field application; and (2) they cannot be applied in the field by spraying.

Thus, there remains a need for further development of compositions for delivery of compounds including cyclopropenes or other plant growth regulators without the above and other disadvantages. The present disclosure addresses this need.

### SUMMARY OF INVENTION

The present invention relates to compositions, methods and materials for delivering a cyclopropene or other active ingredient to a plant. Provided are compositions comprising double encapsulated particles having a waxy coating and being imbedded in a resin matrix. Such double encapsulated particles are further coated with Pickering particles and suspended in an oil. The double encapsulated particles comprise a volatile compound (for example, 1-MCP complex powder) as an active ingredient. Also provided are methods for preparing such compositions and methods for using such compositions.

In one aspect, provided is a collection of double encapsulated particles suspended in an oil medium, wherein each of the double encapsulated particles comprises (a) a resin matrix with a first melting point; (b) a molecular complex coated in a waxy compound with a second melting point where the coated molecular complex is embedded in the resin matrix, and (c) a coating comprising Pickering particles.

In one embodiment, the molecular complex comprises a volatile compound and a molecular encapsulating agent. In a further embodiment, the volatile compound comprises a cyclopropene.

In various embodiments, the composition has any of the more particular features described herein below. In one embodiment, the cyclopropene is of the formula:

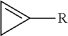

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene is of the formula:

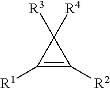

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropene comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin. In another embodiment, the resin matrix comprises polyester resins. In another embodiment, the resin matrix comprises polyester, polyether, epoxy resin, isocyanate, ethylene vinyl acetate copolymer, or combinations thereof. In another embodiment, the resin matrix comprises polycaprolactone polyols. In a further embodiment, the polycaprolactone polyols have molecular weight from 1,000 to 200,000. In another embodiment, the polycaprolactone polyols have molecular weight from 2,000 to 4,000. In one embodiment, the first melting point is from 30° C. to 70° C. In another embodiment, the first melting point is from 50° C. to 60° C.

In one embodiment, the waxy compound comprises carnauba wax, candelilla wax, stearic acid, or combinations thereof. In another embodiment, the second melting point is from 40° C. to 120° C. In another embodiment, the second melting point is from 75° C. to 120° C. In another embodiment, the second melting point is from 60° C. to 90° C. In another embodiment, the second melting point is from 80° C. to 90° C. In another embodiment, the Pickering particles comprise silica particles, clay, oxides, polymer particles, or combinations thereof. In another embodiment, the Pickering particles comprise hydrophobic silica. In a further embodiment, silica surface of the hydrophobic silica is modified by silane coupling agent or organosilicon. In another embodiment, the oil comprises a mixture of alkanes in the C15 to C40 range.

In one embodiment, the ratio of the double encapsulated particles to the oil is from about 2:1 to about 1:100. In another embodiment, the ratio of the double encapsulated particles to the oil is from about 1:1 to about 1:100. In another embodiment, the ratio of the molecular complex to the waxy material is from about 1:1 to about 1:100, by weight. In another embodiment, the ratio of the molecular complex to the waxy material is from about 1:1.5 to about 1:100, by weight. In another embodiment, the ratio of the molecular complex together with the waxy material to the resin is from about 1:1 to about 1:100, by weight. In another embodiment, the ratio of the molecular complex together with the waxy material to the resin is from about 1:1.5 to about 1:100, by weight. In another embodiment, the ratio of the Pickering particles to the oil is from about 1:5 to about 1:25, by weight. In another embodiment, the ratio of the Pickering particles to the oil is from about 1:10 to about 1:24, by weight. In another embodiment, the average particle size of the double encapsulated particles is from about 1 micron to about 200 microns. In another embodiment, the average particle size of the double encapsulated particles is from about 20 microns to about 100 microns. In another embodiment, the composition further comprises at least one surfactant.

In another aspect, provided is a method for preparing a composition. The method comprises (a) blending a molecular complex with a waxy material at a temperature higher than melting point of the waxy material to provide a blend; (b) melting a resin at a temperature higher than its melting point; (c) mixing the blend of step (a) and melted resin of step (b) to provide an uniform molecular complex-waxy material-resin dispersion; (d) mixing Pickering particles with an oil; (e) dispersing the molecular complex-waxy material-resin dispersion of step (c) into the mixture of Pickering particles and oil of step (d); and (f) allowing solidification of the composition at a temperature lower than the melting temperature of the resin. In one embodiment, the method further comprising the step of grinding the blend into powder.

In another embodiment, the blending includes applying shear forces to said blend. In another embodiment, the mixing includes applying shear forces to said mixture. In another embodiment, the dispersing includes applying shear forces to said dispersion. In another embodiment, the solidification does not comprise curing.

In another embodiment, the oil comprises a mixture of alkanes of C15 to C40, or a distillate of petroleum. In another embodiment, the oil comprises a member selected from the group consisting of a mineral oil, an edible oil, and combinations thereof. In another embodiment, the temperature lower than the melting point of the resin is ambient temperature. In another embodiment, the ratio of the molecular complex to the waxy material is from about 1:1 to about 1:100, by weight. In another embodiment, the ratio of the molecular complex to the waxy material is from about 1:1.5 to about 1:100, by weight. In another embodiment, the ratio of the Pickering particles to the oil is from about 1:5 to about 1:25, by weight. In another embodiment, the ratio of the Pickering particles to the oil is from about 1:10 to about 1:24, by weight.

In one embodiment of the methods provided, the molecular complex comprises a cyclopropene and a molecular encapsulating agent. In another embodiment, the cyclopropene is of the formula:

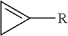

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl. In another embodiment, R is methyl.

In another embodiment, the cyclopropene is of the formula:

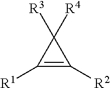

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropene comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In one embodiment, the resin of any of the above-described embodiments comprises a polyester resin. In another embodiment, the resin comprises a resin selected from the group consisting of a polyester, a polyether, an epoxy resin, an isocyanate, an organic amine, an ethylene vinyl acetate copolymer, a natural or synthesized wax, and combinations thereof. In another embodiment, the resin comprises a polycaprolactone polyol. In another embodiment, the resin comprises a polycaprolactone polyol having a molecular weight from about 2,000 to about 4,000. In another embodiment, the resin comprises a polycaprolactone polyol having a melting point from about 50° C. to about 60° C. In another embodiment, the waxy compound comprises carnauba wax, candelilla wax, stearic acid, or combinations thereof. In another embodiment, the waxy compound has a melting point from about 80° C. to about 90° C.

In another aspect, provided is an emulsion comprising an aqueous medium; and any of the composition embodiments described herein. In another aspect, provided is a sprayable slow-release formulation comprising the emulsion disclosed herein.

In another aspect, provided is a method of treating plants or plant parts. The method comprises contacting said plants or plant parts with an emulsion as described herein.

### BRIEF DESCRIPTION OF THE DRAWINGS

FIG. 1 shows representative schematic double matrix encapsulated with HAIP dispersion disclosed herein. HAIP refers to 1-methylcyclopropene/alpha-cyclodextrin complex.

FIG. 2 shows a representative release profile of 1-methylcyclopropene (1-MCP) from HAIP powder upon contact with water.

FIG. 3 shows a representative release profile of 1-methylcyclopropene (1-MCP) from Sample 1-1, as described in Example 1.

FIG. 4 shows a representative release profile of 1-methylcyclopropene (1-MCP) from samples diluted with water: (a) Sample 1-4 within four (4) hours (inventive samples 1 to 4 refer to Samples 1-1, 1-2, 1-3, and 1-4; and (b) Samples 1-4 release rate over five (5) days.

FIG. 5 shows a representative release profile of 1-methylcyclopropene (1-MCP) from Sample 1-5 and Sample 1-6 upon dilution with water within four (4) hours (inventive sample 5 and 6 refer to Sample 1-5 and 1-6).

FIG. 6 shows typical SEM images of (a) HAIP powders and (b) HAIP-carnauba wax core particles (after grinding and sieving through 100 mesh). (a1, b1) Surface morphology; (a2, b2) Cross-section morphology.

FIG. 7 shows typical SEM images of encapsulated particles from (a) Sample 1-2 and (b) Sample 1-3: (a1, b1) Overall surface morphology; (a2, b2) High magnification of (a1, b1); (a3, b3) Cross-section morphology of (a1, b1); (a4, b4) Large particles from the corresponding samples.

### DETAILED DESCRIPTION OF THE INVENTION

Ethylene is well known as a plant hormone affecting the ripening, senescence and leaf abscission of climacteric fruits and vegetables, in which it binds to ethylene receptor sites and causes ripening. In raw crops, it has been shown that ethylene is usually generated when the plant is under environmental stress. The effect of ethylene gas can have negative effects on yield and life storage of many crops.

Accordingly, it is desirable to prevent the pre-harvest adverse effects of ethylene on crops in order to increase their yield. The gas 1-Methylcyclopropene (1-MCP) is a chemical that interferes with the ethylene receptor binding process. The affinity of 1-MCP for the receptors is about 10 times greater than that of ethylene. In freshness management, 1-MCP is effective in blocking ethylene even at very small concentrations (˜100 ppb). However, 1-MCP is a gas difficult to handle and store; it is also flammable above a concentration of 13,300 ppm. As a result, in current agriculture applications, 1-MCP is usually stabilized into clathrate such as α-cyclodextrin (α-CD) to ease handling during storage and transportation. The active ingredient 1-MCP is caged in α-CD and the resulting crystalline complex, called High Active Ingredient Product (HAIP). HAIP is typically composed of 100-150 μm needle like crystals but can be air-milled to a 3-5 μm fine powder if needed. HAIP product can be stored for up to 2 years without loss of 1-MCP at ambient temperature inside a sealed container lined with a moisture barrier. Although the product is more convenient for the application than the 1-MCP gas itself, it still has some disadvantages: (1) it is in a powder form and thus is difficult to handle in the field or in an enclosed space; and (2) it is water-sensitive, and releases 1-MCP gas completely within a short period of time when in contact with water. Upon contact with water or even moisture, 1-MCP gas will be quickly released at a rate which in not compatible with tank use as most of the gas will be lost in the tank headspace before the product had a chance to be sprayed in the field.

In one embodiment, provided is a dispersion containing 1-MCP prepared by a double matrix encapsulation approach which can be done as follows: (1) blend HAIP powder with core materials for example a melted wax and grind the solid mixture into powder; (2) blend the core mixture powder with shell materials for example a melted resin; and (3) disperse the wax powder/melt resin blend into an oil medium containing hydrophobic particles to obtain an oil emulsion/dispersion.

In this process, HAIP powder is imbedded in the core-shell structure with the wax and a resin matrix. Hydrophobic particles serve as Pickering emulsifiers to stabilize the matrix spheres. The hydrophobic particles also have the role of forming an additional layer around the matrix spheres thus providing an additional layer of protection against water penetration. The schematic morphology of the spheres produced by this approach is illustrated in the FIG. 1.

The formulations/compositions prepared based on the disclosed process can have at least one of the following advantages: (1) a unique double encapsulation structure prevents the initial water penetration upon dilution and extends the release rate over a longer period of time; (2) the process disclosed is simple and based on environmentally friendly chemistry: no solvent or conventional surfactant is employed; the encapsulation is conducted without polymerization, and all products are either EPA approved materials or polymers easily added to the EPA inert ingredient list; (3) minimal 1-MCP loss as compared to previous formulations; and (4) the final product appears convenient in use, and the formulation is easy to store and transport.

When the product sample is diluted with water, water needs to go through the oil medium and the hydrophobic particle layer before it can penetrate into the first resin matrix, and then into the internal core wax where it can finally interact with the imbedded α-CD complex and, in turn, release 1-MCP. Thus, compared to pure α-CD complex powder, the compositions/formulations provided can enable a slow release of 1-MCP upon dilution in water. Slowing down the release prevents the premature release of 1-MCP in the tank and allows uniform delivery of 1-MCP to plants. The effective and consistent delivery in field conditions can offer a significant improvement in regulating plant physiology.

The waxy material used in the subject invention may include, but not limited to, carnauba wax, candelilla wax, other wax-like materials (e.g., stearic acid, polyglycerin ester and polyester resins), and mixture thereof. At least one component of the waxes should have a relatively strong affinity with HAIP, so that HAIP particles can be retained within the wax matrix. Preferably, the wax has a melting point below 100° C., and a viscosity below 10,000 centipoises, so that it can be blended with HAIP powder to obtain a uniform mixture.

The resin used in the subject invention may include, but not limited to, pure polymer resins with identical chemical structures and different molecule weights, melting points or viscosities. The resin can also be a blend of several resins. The resin category includes, but not limited to, polyester, polyether, epoxy resin, isocyanate, ethylene vinyl acetate copolymer, natural or synthesized wax, and mixture thereof. At least one component of the resin should have a relatively strong interaction with the HAIP-wax core, so that the core particles can be retained within the resin matrix.

The Pickering particles used in the subject invention may include, but not limited to, silica particles, clay, oxides, polymer particles and mixture thereof. Conventional surfactants are optional to assist in the formation of a stable suspension of particles in oil. Suitable surfactants include, for example, anionic surfactants, nonionic surfactants, and mixtures thereof. Suitable anionic surfactants include, but are not limited to, sulfates and the sulfonates. Suitable nonionic surfactants include, but are not limited to, ethoxylates of fatty alcohols, ethoxylates of fatty acids, block copolymer of polyoxyethylene and polyolefin, and mixture thereof.

The step of solidifying particles may include, but not limited to, naturally cooling down to ambient temperature or using a cooling aid device.

The step of grinding HAIP-wax blends may include, but not limited to, hand grinding by mortar/pestle or grinding by grinders (including room temperature grinding, water cooled grinding and cryo-grinding, etc).

The oil used in the subject invention may include, but not limited to, mineral oils, light mineral oils, Isopar oils, Unipar oils and other hydrocarbon oils, edible oils and mixture thereof.

A suitable oil medium may include a mineral oil, an edible oil or a mixture thereof. In one embodiment, the oil medium comprises a mineral oil, which may comprise light mixtures of alkanes in the C15 to C40 range, or a distillate of petroleum. Further examples of oils that can be used include, but are not limited to, mineral oil, light mineral oils, Isopar oil, Unipar oil and other hydrocarbon oils, edible oils and mixture thereof.

Suitable surfactants include, for example, anionic surfactants, nonionic surfactants, and mixtures thereof. Some suitable anionic surfactants include, but not limited to, sulfates, and the sulfonates. Some suitable nonionic surfactants include, but not limited to, ethoxylates of fatty alcohols, ethoxylates of fatty acids, block copolymer of polyoxyethylene and polyolefin, and mixture thereof.

Suitable resins are not limited to a polymer resin with the same chemical structures or same molecule weight, but can also include blends of two or more resins. Suitable resins for use in the methods and compositions disclosed herein include, but are not limited to, polyester, polyether, epoxy resin, isocyanate, organic amine, ethylene vinyl acetate copolymer, natural or synthesized wax, and mixture thereof. In one embodiment, at least one component of the resin has an attraction, preferably a relatively strong interaction with a cyclopropene molecular complex, preferably with HAIP, which can aid in the detention of complex particles within the resin matrix. In one embodiment, the resin has a melting point below 100° C., and a viscosity below 10,000 centipoises.

In one embodiment, the resin comprises a polyester resin. One example of a suitable polyester resin is a polycaprolactone polyol (“PCL”). In various embodiments, the molecular weight of the polycaprolactone polyol is from 1,000 to 200,000; from 2,000 to 50,000; from 2,000 to 8,000; or from 2,000 to 4,000, inclusive of all ranges within these ranges. In various embodiments, the polycaprolactone polyol has a melting point from 30° C. to 120° C.; from 40° C. to 80° C.; or from 50° C. to 60° C., inclusive of all ranges within these ranges. For example, resins including PCL with molecular weight about 120,000 can have a melting point about 60° C. In one embodiment, this kind of resin with a 60° C. melting point is useful for the disclosed methods and compositions. 1-Methylcyclopropene/alpha-cyclodextrin complex (referred to herein as “HAIP”) is known to tolerate temperature about 100° C. for a short duration (for example four minutes) without significant activity loss.

In one embodiment, suitable resins may have melting point of 55° C. or higher; 65° C. or higher; or 70° C. or higher. In another embodiment, suitable resins may have melting point of 100° C. or lower; or 90° C. or lower.

Another method of assessing fatty compounds is the temperature of onset of the melting point. To determine the onset temperature, the exotherm curve (heat flow vs. temperature) produced by the DSC for the melting point transition is observed. The baseline is determined, and a corrected heat-flow curve calculated by subtracting the baseline from the original heat-flow curve. The maximum heat-flow value of the corrected curve (HFMAX) is determined The onset temperature is the lowest temperature at which the heat-flow value on the corrected curve is equal to 0.1*HFMAX. Suitable resins may have onset temperature of 45° C. or higher; or 55° C. or higher.

In various embodiments, the ratio of the solid particles (also referred to herein as “resin/complex particles”) to the oil may be from about 1:5 to about 1:25; or from about 1:10 to about 1:24, inclusive of all ranges within these ranges. In embodiments including one or more surfactants, the ratio of the surfactants to the oil may be from about 2:1 to about 1:20; or from about 1:1 to about 1:10, inclusive of all ranges within these ranges. In various embodiments including HAIP powders, the ratio of the HAIP powder to resins may be from about 1:1 to 1:100; or from about 1:2: to about 1:100, inclusive of all ranges within these ranges. In various embodiments, the ratio of the resins to the oil may be from about 2:1 to about 1:100; or from about 1:1 to about 1:100, inclusive of all ranges within these ranges.

As used herein, the term “resin” is synonymous with “polymer” and refers to a relatively large molecule made up of the reaction products of smaller chemical repeat units. The repeat units may be all identical or may include two or more different repeat units. Polymer molecules may have structures including linear, branched, star-shaped, and mixtures thereof. Polymer molecular weights can be measured by standard methods such as, for example, size exclusion chromatography (SEC, also called gel permeation chromatography or GPC). Polymers have number-average molecular weight (Mn) of greater than 700. “Oligomer” as used herein is also a molecule made up of the reaction products of smaller chemical repeat units called monomer units. Oligomers have molecular weight of 700 or less.

A thermoplastic is a polymer that becomes pliable or moldable above a specific temperature, and returns to a solid state upon cooling. In term s of structure characteristics, it can be linear, branched, or star-shaped, where no chemical crosslinking between different molecules. Resins like PCT with M.W. ˜120,000 also melt at 60° C. Such resin can be called thermoplastic.

As used herein, a material is water-insoluble if the amount of that material that can be dissolved in water at 25° C. is 1 gram of material or less per 100 grams of water.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

As used herein, the “aspect ratio” of a solid particle is the ratio of the particle's longest dimension to that particle's shortest dimension. A particle's longest dimension is the length of the longest possible line segment (“segment L”) that passes through the particle's center of mass and that has each of its end points on the surface of the particle. That particle's shortest dimension is the length of the shortest possible line segment (“segment S”) that passes through the particle's center of mass, that has each of its end points on the surface of the particle, and that is perpendicular to segment L. The aspect ratio is the ratio of the length of segment L to the length of segment S.

As used herein, the “diameter” of a non-spherical particle is the average of the length of that particle's segment L and that particle's segment S. It is noted that, when the particle is spherical, this definition gives the “diameter” in the usual sense.

As used herein, when a property of a powder is described as having a “median” value, it is contemplated that half of the total volume of powder particles will consist of particles that have that property with a value above that median value and that half of the total volume of powder particles will consist of particles that have that property with a value below that median value.

The practice of the present invention involves the use of one or more cyclopropene compound. As used herein, a cyclopropene compound is any compound with the formula

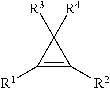

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The compositions disclosed herein include at least one molecular encapsulating agent. In preferred embodiments, at least one molecular encapsulating agent encapsulates one or more cyclopropene compound or a portion of one or more cyclopropene compound. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In one embodiment, complex powders may have median particle diameter of 100 micrometers or less; 75 micrometers or less; 50 micrometers or less; or 25 micrometers or less. In another embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

In the practice of the present invention, one or more oils are used. As used herein, the phrase “oil” refers to a compound that is liquid at 25° C. and 1 atmosphere pressure and that has a boiling point at 1 atmosphere pressure of 30° C. or higher. As used herein, “oil” does not include water, does not include surfactants, and does not include dispersants.

In some embodiments, one or more oil may be used that has boiling point of 50° C. or higher; or 75° C. or higher; or 100° C. or higher. In some embodiments, every oil that is used has boiling point of 50° C. or higher. In some embodiments, every oil that is used has boiling point of 75° C. or higher. In some embodiments, every oil that is used has boiling point of 100° C. or higher. Independently, in some of the embodiments that use oil, one or more oil may be used that has an average molecular weight of 100 or higher; or 200 or higher; or 500 or higher. In some embodiments, every oil that is used has average molecular weight of 100 or higher. In some embodiments, every oil that is used has average molecular weight of 200 or higher. In some embodiments, every oil that is used has average molecular weight of 500 or higher.

An oil may be either a hydrocarbon oil (i.e., an oil whose molecule contains only atoms of carbon and hydrogen) or a non-hydrocarbon oil (i.e., an oil whose molecule contains at least at least one atom that is neither carbon nor hydrogen).

Some suitable hydrocarbon oils are, for example, straight, branched, or cyclic alkane compounds with 6 or more carbon atoms. Some other suitable hydrocarbon oils, for example, have one or more carbon-carbon double bond, one or more carbon-carbon triple bond, or one or more aromatic ring, possibly in combination with each other and/or in combination with one or more alkane group. Some suitable hydrocarbon oils are obtained from petroleum distillation and contain a mixture of compounds, along with, in some cases, impurities. Hydrocarbon oils obtained from petroleum distillation may contain a relatively wide mixture of compositions or may contain relatively pure compositions. In some embodiments, hydrocarbon oils are used that contain 6 or more carbon atoms. In some embodiments, hydrocarbon oils are used that contain 18 or fewer carbon atoms. In some embodiments, every hydrocarbon oil that is used contains 18 or fewer carbon atoms. In some embodiments, every hydrocarbon oil that is used contains 6 or more carbon atoms. Some suitable hydrocarbon oils include, for example, hexane, decane, dodecane, hexadecane, diesel oil, refined paraffinic oil (e.g., Ultrafine™ spray oil from Sun Company), and mixtures thereof. In some embodiments, every oil that is used is a hydrocarbon oil.

Among embodiments that use non-hydrocarbon oil, some suitable non-hydrocarbon oils are, for example, fatty non-hydrocarbon oils. “Fatty” means herein any compound that contains one or more residues of fatty acids. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups, that are either naturally occurring or that have been added. Some suitable fatty non-hydrocarbon oils are, for example, fatty acids; esters of fatty acids; amides of fatty acids; dimers, trimers, oligomers, or polymers thereof; and mixtures thereof.

Some of the suitable fatty non-hydrocarbon oils, are, for example, esters of fatty acids. Such esters include, for example, glycerides of fatty acids. Glycerides are esters of fatty acids with glycerol, and they may be mono-, di-, or triglycerides. A variety of triglycerides are found in nature. Most of the naturally occurring triglycerides contain residues of fatty acids of several different lengths and/or compositions. Some suitable triglycerides are found in animal sources such as, for example, dairy products, animal fats, or fish. Further examples of suitable triglycerides are oils found in plants, such as, for example, coconut, palm, cottonseed, olive, tall, peanut, safflower, sunflower, corn, soybean, linseed, tung, castor, canola, citrus seed, cocoa, oat, palm, palm kernel, rice bran, cuphea, or rapeseed oil.

Among the suitable triglycerides, independent of where they are found, are those, for example, that contain at least one fatty acid residue that has 14 or more carbon atoms. Some suitable triglycerides have fatty acid residues that contain 50% or more by weight, based on the weight of the residues, fatty acid residues with 14 or more carbon atoms, or 16 or more carbon atoms, or 18 or more carbon atoms. One example of a suitable triglyceride is soybean oil.

Suitable fatty non-hydrocarbon oils may be synthetic or natural or modifications of natural oils or a combination or mixture thereof. Among suitable modifications of natural oils are, for example, alkylation, hydrogenation, hydroxylation, alkyl hydroxylation, alcoholysis, hydrolysis, epoxidation, halogenation, sulfonation, oxidation, polymerization, and combinations thereof. In some embodiments, alkylated (including, for example, methylated and ethylated) oils are used. One suitable modified natural oil is methylated soybean oil.

Also among the suitable fatty non-hydrocarbon oils are self-emulsifying esters of fatty acids.

Another group of suitable non-hydrocarbon oils is the group of silicone oils. Silicone oil is an oligomer or polymer that has a backbone that is partially or fully made up of —Si—O— links. Silicone oils include, for example, polydimethylsiloxane oils. Polydimethylsiloxane oils are oligomers or polymers that contain units of the form

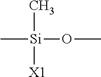

where at least one of the units has X1=CH₃. In other units, X1 may be any other group capable of attaching to Si, including, for example, hydrogen, hydroxyl, alkyl, alkoxy, hydroxyalkyl, hydroxyalkoxy, alkylpolyalkoxyl, substituted versions thereof, or combinations thereof. Substituents may include, for example, hydroxyl, alkoxyl, polyethoxyl, ether linkages, ester linkages, amide linkages, other substituents, or any combination thereof. In some embodiments, every oil that is used is a silicone oil.

In some suitable polydimethylsiloxane oils, all X1 groups are groups that are not hydrophilic. In some suitable polydimethylsiloxane oils, all X1 groups are alkyl groups. In some suitable polydimethylsiloxane oils, all X1 groups are methyl. In some embodiments, every silicone oil is a polydimethylsiloxane oil in which all X1 groups are methyl. In some suitable polydimethylsiloxanes, at least one unit has an X1 group that is not methyl; if more than one non-methyl X1 unit is present, the non-methyl X1 units may be the same as each other, or two or more different non-methyl X1 units may be present. Polydimethylsiloxane oils may be end-capped with any of a wide variety of chemical groups, including, for example, hydrogen, methyl, other alkyl, or any combination thereof. Also contemplated are cyclic polydimethylsiloxane oils. Mixtures of suitable oils are also suitable.

A carrier composition of the present disclosure may be used for treating plants or plant parts in any way. For example, a carrier composition may be mixed with other materials or may be used directly.

In another aspect, the present disclosure provides a method of using a carrier composition as described herein for a formation of an aqueous slurry. An aqueous slurry can be formed when the composition provided is mixed with an aqueous medium. To form such a slurry, the aqueous medium may be mixed directly with the carrier composition. It is expected that the resin/complex particles of the carrier composition remain intact in the slurry. It is also contemplated that most or all of the resin/complex particles will be dispersed in the slurry as individual particles rather than as agglomerates thereof. The resin/complex particles may require mechanical agitation to remain suspended in the aqueous medium, or they may remain suspended without agitation.

The amount of carrier composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The amount of water in the aqueous medium used in the slurry may be, by weight based on the weight of aqueous medium, 80% or more; 90% or more; or 95% or more.

The slurry may optionally include one or more adjuvants, for example and without limitation, one or more metal complexing agent, alcohol, extender, pigment, filler, binder, plasticizer, lubricant, wetting agent, spreading agent, dispersing agent, sticker, adhesive, defoamer, thickener, transport agent, emulsifying agent or mixtures thereof. Some of such adjuvants commonly used in the art can be found in the John W. McCutcheon, Inc. publication Detergents and Emulsifiers, Annual, Allured Publishing Company, Ridgewood, N.J., U.S.A. Examples of metal-complexing agents, if used, include chelating agents. Examples of alcohols, if used, include alkyl alcohols with 4 or fewer carbon atoms.

Also provided is a method of treating plants by bringing the slurry into contact with plants or plant parts. Such contacting may be performed in any location, including inside enclosed spaces (for example, containers, rooms, or buildings) or outside of an enclosed space. In one embodiment, such contacting is performed outside of any enclosed space. As used herein, “outside of any enclosed space” means outside of any building or enclosure or else in a room or building that is ventilated to outdoor atmosphere. In another embodiment, such contacting is performed outside of any building or enclosure. In a further embodiment, such contacting is performed in an outdoor field or plot.

The slurry of the present disclosure may be brought into contact with plants or plant parts by methods known in the art. Examples of methods include dipping plant parts into the slurry and applying slurry to plants or plant parts by spraying, foaming, brushing, or combinations thereof. Other examples include spraying the slurry onto plants or plant parts and dipping plant parts into the slurry. Additional examples include spraying the slurry onto plants or plant parts.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

As used herein, the phase “plant growth regulator” includes, but not limited to, ethylene, cyclopropenes, glyphosate, glufosinate, and 2,4-D. Other suitable plant growth regulators have been disclosed in International Patent Application Publication WO 2008/071714A1, which is incorporated by reference in its entirety.

Additional suitable plant growth regulators include famoxadone; or carboxylic amides selected from benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamid, tiadinil, 4-difluoromethyl-2-methyl-thiazol-5-carboxylic acid-(4′-bromo-biphenyl-2-yl)-amide, 4-difluoromethyl-2-methyl-thiazol-5-carboxylic acid-(4′-trifluoromethyl-biphenyl-2-yl)-amide, 4-difluoromethyl-2-methyl-thiazol-5-carboxylic acid-(4′-chloro-3′-fluoro-biphenyl-2-yl)-amide, 3-difluoromethyl-1-methyl-pyrazol-4-carboxylic acid-(3′,4′-dichloro-4-fluoro-biphenyl-2-yl)-amide, 3,4-dichloro-isothiazol-5-carboxylic acid-(2-cyano-phenyl)-amide, dimethomorph, flumorph, flumetover, fluopicolide (picobenzamid), zoxamide, carpropamide, diclocymet, mandipropamid, N-(2-(4-[3-4-chloro-phenyl)-prop-2-inyloxy]-3-methoxy-phenyl)-ethyl)-2-methanesulfo-nylamino-3-methyl-butyramid and N-(2-(4-[3-(4-chloro-phenyl)-prop-2-inyloxy]-3-methoxy-phenyl)-ethyl)-2-ethanesulfonylamino-3-methyl-butyramide.

Additional suitable plant growth regulators include azoles selected from bitertanole, bromuconazole, cyproconazole, difenoconazole, diniconazole, enilconazole, epoxiconazole, fenbuconazole, flusila-zole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticona-zole, cyazofamid, imazalil, pefurazoate, prochloraz, triflumizol, benomyl, carbendazim, fuberidazole, thiabendazole, ethaboxam, etridiazole and hymexa-zole; and nitrogen-containing heterocyclic compounds selected from fluazinam, pyrifenox, 3-[5-(4-chloro-phenyl)-2,3-dimethyl-isoxazolidin-3-yl]-pyridine, bupirimat, cyprodinil, ferimzon, fenarimol, mepanipyrim, nuarimol, pyrimethanil, tri-forin, fludioxonil, fenpiclonil, aldimorph, dodemorph, fenpropimorph, tridemorph, iprodion, procymidon, vinclozolin, acibenzolar-S-methyl, anilazin, captan, captafol, dazomet, diclomezine, fenoxanil, folpet, fenpropidin, famoxadone, fenamidone, octhilinon, probenazol, proquinazid, pyroquilon, quinoxyfen, tricyclazol, 2-butoxy-6-iodo-3-propyl-chromen-4-one, 3-(3-bromo-6-fluoro-2-methyl-indole-1-sulfonyl)-[1,2,4]triazole-1-sulfonic acid dimethylamide.

Additional suitable plant growth regulators include carbamates and dithiocarbamates selected from ferbam, mancozeb, metiram, metam, propineb, thiram, zineb, ziram, diethofencarb, flubenthiavalicarb, iprovalicarb, propamocarb, 3-(4-chloro-phenyl)-3-(2-isopropoxy carbonylamino-3-methyl-butyrylamino)-propionic acid methylester and N-(1-(1-(4-cyanophenyl)ethanesulfonyl)-but-2-yl) carbamic acid-(4-fluorophenyl)ester; guanidines selected from dodin, iminoctadine and guazatin; and antibiotics selected from kasugamycin, polyoxine, streptomycin and valida-mycin A.

Additional suitable plant growth regulators include fentin salts; sulfur-containing heterocyclic compounds selected from isoprothiolan and dithianon; organophosphorous compounds selected from edifenphos, fosetyl, fosetyl-aluminium, iprobenfos, pyrazophos, tolclofos-methyl, phosphoric acid and the salts thereof; organo-chloro compounds selected from thiophanate methyl, chlorothalonil, dichlofluanid, tolylfluanid, flusulfamid, phthalide, hexachlorbenzene, pency-curon, quintozen; nitrophenyl derivatives selected from binapacryl, dinocap and dinobuton; and inorganic active ingredients selected from Bordeaux composition, copper acetate, copper hydroxide, copper oxychloride, basic copper sulfate and sulfur.

Additional suitable plant growth regulators include spiroxamine; cyflufenamide; cymoxanil; metrafenone; organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon; carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicar and triazamate; and pyrethroids selected from allethrin, bifenthrin, cyfluthrin, cyhalothrin, cy-phenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin.

Additional suitable plant growth regulators include (a) chitin synthesis inhibitors that are selected from the benzoylureas chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole and clofentazine; (b) ecdysone antagonists that are selceted from halofenozide, methoxyfenozide, tebufenozide and azadirachtin; (c) juvenoids that are selected from pyriproxyfen, methoprene and fenoxycarb; and (d) lipid biosynthesis inhibitors that are selected from spi-rodiclofen, spiromesifen and spirotetramat.

Additional suitable plant growth regulators include nicotinic receptor agonists/antagonists compoundsselected from clothianidin, dinotefuran, imidacloprid, thiamethoxam, nitenpyram, acetamiprid, thiacloprid; and the thiazol compound of formula (I):

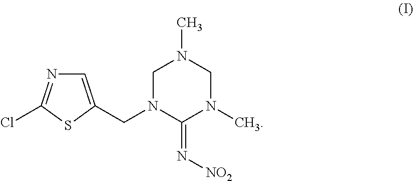 [SMILES: CN1CN(C)/C(=N\[N+](=O)[O-])N(Cc2cnc(Cl)s2)C1]

Additional suitable plant growth regulators include chlorfenapyr; cyromazine; indoxacarb; piperonyl butoxide; METI I compounds selected from fenazaquin, pyridaben, tebufenpyrad, tolfenpyrad and flufenerim; METI II and III compounds selected from acequinocyl, fluacyprim and hydramethylnon; oxidative phosphorylation inhibitor compounds selected from cyhexatin, diafenthiuron, fenbutatin oxide and propargite; and GABA antagonist compoundsselected from acetoprole, endosulfan, ethi-prole, fipronil, vaniliprole, pyrafluprole, pyriprole and the phenylpyrazole compound of formula (II):

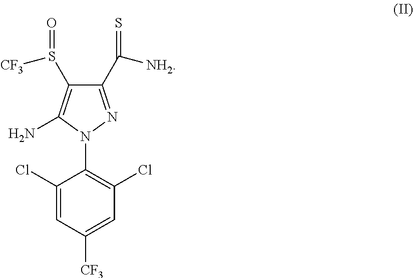 [SMILES: NC(=S)c1nn(-c2c(Cl)cc(C(F)(F)F)cc2Cl)c(N)c1S(=O)C(F)(F)F]

Additional suitable plant growth regulators include benclothiaz, bifenazate, cartap, flonicamid, pyridalyl, pymetrozine, sulfur, thiocyclam, flubendiamide, cyenopyrafen, flupyra-zofos, cyflumetofen, amidoflumet, the aminoquinazolinone compound of formula r (III):

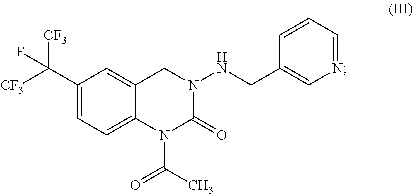 [SMILES: CC(=O)N1C(=O)N(NCc2cccnc2)Cc2cc(C(F)(C(F)(F)F)C(F)(F)F)ccc21]

and anthranilamide compounds of formula r (IV):

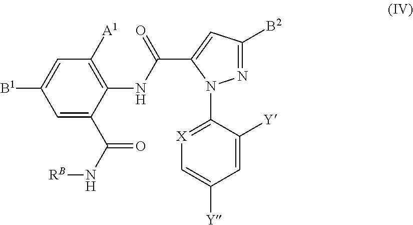

wherein A¹ is CH₃, Cl, Br, or I; X is C—H, C—Cl, C—F or N; Y′ is F, Cl, or Br; Y″ is F, Cl, or CF₃; B¹ is hydrogen, Cl, Br, I, or CN; B² is Cl, Br, CF₃, OCH₂CF₃, or OCF₂H, and R^{B} is hydrogen, CH₃ or CH(CH₃)₂.

Additional suitable plant growth regulators include lipid biosynthesis inhibitors selected from chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate, bensulide and pinoxaden; ALS inhibitors selected from amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid, pyrithiobac, flucetosulfuron, orthosulfamuron, pyrimisulfan; and photosynthesis inhibitors selected from atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthy-lazine, terbutryne, trietazine, ametridione, amibuzin, hexazinone, isomethiozin, metamitron, metribuzin, bromacil, isocil, lenacil, terbacil, brompyrazon, chlorida-zon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluron, anisuron, buturon, chlorbromuron, chlo-returon, chlorotoluron, chloroxuron, difenoxuron, dimefuron, diuron, fenuron, fluometuron, fluothiuron, isoproturon, linuron, methiuron, metobenzuron, meto-bromuron, metoxuron, monolinuron, monuron, neburon, parafluron, phenobenzuron, siduron, tetrafluron, thidiazuron, cyperquat, diethamquat, difenzo-quat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol.

Additional suitable plant growth regulators include protoporphyrinogen-IX oxidase inhibitors selected from acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid, and bencarbazone; bleacher herbicides selected from metflurazon, norflurazon, flufenican, diflufenican, picolinafen, beflubutamid, fluridone, flurochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethyl-phenoxy)-2-(4-trifluoromethylphenyl)pyrimidine, topramezone, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoro-methyl)-3-pyridinyl]carbonyl}bicylo[3.2.1]oct-3-en-2-one, 4-hydroxy-3-[4-(methylsulfonyl)-2-nitrobenzoyl]bicyclo[3.2.1]-oct-3-en-2-one, 2-[2-chloro-4-(methylsulfonyl)-3-[(2,2,2-trifluoroethoxy)methyl]benzoyl]-3-hydroxy-2-cyclohexen-1-one and pyrasulfotole.

Additional suitable plant growth regulators include glyphosate in its acid form or as a derivative thereof, such as the mono isopropylammonium salt, the sodium salt, trimesium salt (sulfosate) or a mixture thereof; glutamine synthase inhibitors selected from glufosinate and bilanaphos; asulam; mitose inhibitors selected from benfluralin, butralin, dinitramine, ethalflu-ralin, fluchloralin, isopropalin, methalpropalin, nitralin, oryzalin, pendimethalin, prodiamine, profluralin, trifluralin, amiprofos-methyl, butamifos, dithiopyr, thia-zopyr, propyzamide, tebutam, chlorthal, carbetamide, chlorbufam, chlorpropham and propham; VLCFA inhibitors selected from acetochlor, alachlor, butachlor, bu-tenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane; cellulose biosynthesis inhibitors selected from dichlobenil, chlorthiamid, isoxaben and flupoxam; decoupler herbicides selected from dinofenate, dinoprop, dinosam, di-noseb, dinoterb, DNOC, etinofen and medinoterb.

Additional suitable plant growth regulators include auxin herbicides selected from clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, clopyralid, fluroxypyr, picloram, tri-clopyr, benazolin, aminopyralid, quinclorac, and quinmerac; auxin transport inhibitors selected from naptalam and diflufenzopyr; benzoylprop, flamprop, flamprop-M, bromobutide, chlorflurenol, cinmethylin, methyldymron, etobenzanid, fosamine, metam, pyributicarb, oxazi-clomefone, dazomet, triaziflam, methyl bromide, and endothal; inhibitors of ethylene biosynthesis which block the conversion of ACC into ethylene selected from Co²⁺ or Ni²⁻ ions; radical-scavenging phenolic substances including n-propyl gallate; polyamines including putrescine, spermine, spermidine; structural ACC analogs including alpha-aminoisobutyric acid, L-aminocyclopropene-1-carboxylic acid; salicylic acid including its synthetic analogon acibenzolar-S-methyl; structural analogs of ascorbic acid which act as inhibitors of ACC oxidase including prohexadione-Ca or trinexapac-ethyl; triazolyl compounds as inhibitors of cytochrome P-450-dependent monooxygenase; inhibitors of the action of ethylene 2,5-norbornadiene, and 3-amino-1,2,4-triazole or Ag²⁺ ions; and ethylene biosynthesis inhibitors which inhibit the conversion of S-adenosyl-L-methionine into 1-aminocyclopropane-1-carboxylic acid (ACC) including derivatives of vinylglycine, hydroxylamines, or oxime ether.

### EXAMPLES

### Example 1

### Sample Preparation and Testing

Release rate of 1-MCP in water diluted samples is investigated as follows: Mix about 3 grams of sample (described below) and 0.5 gram of surfactant in a 25 ml vial under shearing. About 0.6 gram of the mixture is weighted into a 250 ml glass bottle, and then 2 ml of millli Q water and 0.25 ml of cis-2-butene are added. The bottle is placed on a multi-purpose rotator under constant gentle shaking to ensure the sample is wetted and diluted by water, forming a milk-like emulsion. The 1-MCP gas released by the formulation in the glass bottle is tracked periodically up to 4 hours. The analysis of the 1-MCP concentration is done by gas chromatography (0.25 ml injections). After 4 hours, the bottle is heated in a water bath to a temperature slightly above the melting point of the wax for 1 hour to entirely liberate 1-MCP. From the measured concentration of 1-MCP, the amount of sample tested and the entire concentration of 1-MCP release after heating the sample, it becomes possible to calculate the release percentage of 1-MCP at each time point.

The release profiles of 1-MCP from the samples are compared to the release of 1-MCP from HAIP powder. In order to measure the release of 1-MCP from HAIP, about 20 mg of HAIP powder is sealed into a 250 ml glass bottle after 2 ml of millli Q water and 0.25 ml cis-2-butene are added. 1-MCP is measured using the gas chromatography analysis.

Various samples are prepared in this example and listed in Table 1. Preparation of each sample is set forth below.

Sample 1-1: (1) 29.108 grams of carnauba wax is placed in a vessel and heated up to its melting point, 90° C. After the wax melted, 10.034 grams of HAIP powder is gradually added under shearing (1500 rpm for 10 minutes), followed by mixing for another 10 minutes to obtain viscous uniform HAIP-wax dispersion (HAIP loading 25.6349%). The dispersion is then poured out to a glass dish and hardened by cooling. The resulting solidified HAIP-wax blend is then broken up in pieces, ground to powder and sieved to 48-75 μm (between 200 and 300 mesh).

(2) 2.6707 grams of polyester resin (PCL 230B) is added to a vessel and melted to a temperature slightly above its melting point, 60° C. After the resin melted, 0.1553 grams of HAIP-wax powder (1) is added, and the mixture is thoroughly mixed at 600 rpm for 5 minutes to obtain a uniform HAIP-wax-resin dispersion.

(3) 0.4204 grams of silica powder (AEROSIL® 8202) and 6.5866 grams of mineral oil are added into a vessel. The mixture is thoroughly mixed by high-speed shearing at 12,000 rpm, followed by heating to 60° C.

(4) HAIP-wax-resin dispersion (2) is blended with silica-oil mixture (3) at 60° C. under stirring at 1000 rpm for 10 minutes to form particles wherein HAIP is imbedded. The HAIP-wax-resin/silica-oil emulsion is then cooled down to allow solidification of the emulsified particles.

Sample 1-2: (1) 5.018 grams of carnauba wax is added to a vessel and heated up to its melting point, 90° C. After the wax melted, 1.250 grams of HAIP powder is gradually added under shearing at 1500 rpm for 10 minutes, followed by mixing for another 10 minutes to obtain viscous uniform HAIP-wax dispersion (HAIP loading 19.9489%). The dispersion is then poured out to a glass dish and allows solidification by cooling. The resulting solidified HAIP-wax blend is then broken up in pieces, ground to powder and sieved to 75-150 μm (between 100 and 200 mesh).

(2) 2.7560 grams of polyester resin (PCL 230B) is added to a vessel and melted to a temperature slightly above its melting point, 60° C. After the resin melted, 0.3060 grams of HAIP-wax powder (1) is added. The mixture is thoroughly mixed by shearing at 600 rpm for 5 minutes to obtain a uniform HAIP-wax-resin dispersion.

(3) 0.4217 grams of silica powder (AEROSIL® 8202) and 6.6073 g mineral oil are added into a vessel. The mixture is thoroughly mixed by high-speed shearing at 12,000 rpm, followed by heating to 60° C.

(4) HAIP-wax-resin dispersion (2) is blended with silica-oil mixture (3) at 60° C. under stirring at 1000 rpm for 10 minutes to form particles wherein HAIP is imbedded. The HAIP-wax-resin/silica-oil emulsion is then cooled down to allow solidification of the emulsified particles.

Sample 1-3: (1) 59.1120 grams of carnauba wax is placed in a vessel and heated up to its melting point, 90° C. After the wax melted, 40.064 grams of HAIP powder is gradually added under shearing at 1500 rpm for 10 minutes, followed by mixing for another 10 minutes to obtain viscous uniform HAIP-wax dispersion (HAIP loading 40.3969%). The dispersion is then poured out to a glass dish and allows solidification by cooling. The resulting solidified HAIP-wax blend is then broken up in pieces, ground to powder and sieved to 48-75 μm (between 200 and 300 mesh).

(2) 2.4508 g polyester resin (PCL 230B) is added to a vessel and melted at temperature slightly above its melting point, 60° C. After the resin melted, 0.6032 grams of HAIP-wax powder (1) is added. The mixture is thoroughly mixed by shearing at 600 rpm for 5 minutes to obtain a uniform HAIP-wax-resin dispersion.

(3) 0.4220 grams of silica powder (AEROSIL® 8202) and 6.6120 grams of mineral oil are added into a vessel, and the mixture is thoroughly mixed by high-speed shearing at 12,000 rpm, followed by heating to 60° C.

(4) HAIP-wax-resin dispersion (2) is blended with silica-oil mixture (3) at 60° C. under stirring at 1000 rpm for 10 minutes to form particles wherein HAIP is imbedded. The HAIP-wax-resin/silica-oil emulsion is then cooled down to allow solidification of the emulsified particles.

Sample 1-4: (1) 1.8014 grams of polyester resin (PCL 230B) is added to a vessel and melted to a temperature slightly above its melting point, 60° C. After the resin melted, 1.1866 g HAIP-wax powder (same as (1) in Sample 1-3) is added, and the mixture is thoroughly mixed by shearing at 600 rpm for 5 minutes to obtain uniform HAIP-wax-resin dispersion.

(2) 0.4245 grams of silica powder (AEROSIL® 8202) and 6.6505 grams of mineral oil are added into a vessel, and the mixture is thoroughly mixed by high-speed shearing at 12,000 rpm, followed by heating to 60° C.

(3) HAIP-wax-resin dispersion (2) is blended with silica-oil mixture (3) at 60° C. under stirring of 1000 rpm for 10 minutes to form particles wherein HAIP is imbedded. The HAIP-wax-resin/silica-oil emulsion is then cooled down to allow solidification of the emulsified particles.

Sample 1-5: (1) 59.124 grams of candelilla wax is placed in a vessel and heated up to its melting point, 90° C. After the wax melted, 40.433 grams of HAIP powder is gradually added under shearing at 1500 rpm within 10 minutes, followed by mixing for another 10 minutes to obtain a viscous uniform HAIP-wax dispersion (HAIP loading 40.6129%). The dispersion is then poured out to a glass dish and allows solidification by cooling. The resulting solidified HAIP-wax blend is then broken up in pieces, ground to powder and sieved to 48-75 μm (between 200 and 300 mesh).

(2) 2.3186 grams of polyester resin (PCL 230B) is added to a vessel and melted at temperature slightly above its melting point, 60° C. After the resin melted, 0.5664 grams of HAIP-wax powder (1) is added. The mixture is thoroughly mixed by shearing at 600 rpm for 5 minutes to obtain uniform HAIP-wax-resin dispersion.

(3) 0.4215 grams of silica powder (AEROSIL® R202)and 6.6035 grams of mineral oil are added into a vessel, and the mixture is thoroughly mixed by high-speed shearing at 12,000 rpm, followed by heating to 60° C.

(4) HAIP-wax-resin dispersion (2) is blended with silica-oil mixture (3) at 60° C. under stirring of 1000 rpm for 10 minutes to form particles wherein HAIP is imbedded. The HAIP-wax-resin/silica-oil emulsion is then cooled down to allow solidification of the emulsified particles.

Sample 1-6: (1) 15.00 g stearic acid is placed in a vessel and heated up to its melting point, 90° C. After the wax melted, 3.75 g HAIP powder is gradually added under shearing at 1500 rpm within 10 minutes, followed by mixing for another 10 minutes to obtain viscous uniform HAIP-wax dispersion (HAIP loading 20.00%). The dispersion is then poured out to a glass dish and allows solidification by cooling. The resulting solidified HAIP-wax blend is then broken up in pieces, ground to powder and sieved to 75-150 μm (between 100 and 200 mesh).

(2) 3.1500 grams of polyester resin (PCL 230B) is added to a vessel and melted at temperature slightly above its melting point, 60° C. After the resin melted, 0.0641 grams of HAIP-stearic acid powder (1) is added. The mixture is thoroughly mixed by shearing at 600 rpm for 5 minutes to obtain uniform HAIP-wax-resin dispersion.

(3) 0.4222 grams of silica powder (AEROSIL® 8202) and 6.6148 grams of mineral oil are charged into a vessel, and the mixture was thoroughly mixed by high-speed shearing at 12,000 rpm, followed by heating to 60° C.

(4) HAIP-stearic acid-resin dispersion (2) is blended with silica-oil mixture (3) at 60° C. under stirring of 1000 rpm for 10 minutes to form particles wherein HAIP is imbedded. The HAIP-wax-resin/silica-oil emulsion is then cooled down to allow solidification of the emulsified particles.

TABLE 1
List of samples (formulations).

| | | Sample | Sample | Sample | Sample | Sample | Sample | |
|---|---|---|---|---|---|---|---|---|
| Ingredients | | 1-1 | 1-2 | 1-3 | 1-4 | 1-5 | 1-6 | Control |
| HAIP-wax | HAIP- | 0.1553 g | 0.3060 g | 0.6032 g | 1.1866 g | / | / | HAIP |
| particles | carnauba | (25.6349%; | (19.9489%; | (40.3969%; | (40.3969%; | | | powder |
| (HAIP | wax | 200 mesh) | 100 mesh) | 200 mesh) | 200 mesh) | | | |
| loading) | HAIP- | | / | / | / | 0.5664 g | / | |
| (Particle | candelilla | | | | | (40.6129%; | | |
| size) | wax | | | | | 200 mesh) | | |
| | HAIP- | | / | / | / | / | 0.0641 g | |
| | stearic | | | | | | (20.000%; | |
| | acid | | | | | | 100 mesh) | |

| | | | | | | |
|---|---|---|---|---|---|---|
| Polyester resin: | 2.6707 g | 2.7560 g | 2.4508 g | 1.8014 g | 2.3186 g | 3.1500 g |
| PCL230B | | | | | | |
| Silica powder: | 0.4204 g | 0.4217 g | 0.4220 g | 0.4245 g | 0.4215 g | 0.4222 g |
| AEROSIL ®R202 | | | | | | |
| Mineral oil | 6.5866 g | 6.6073 g | 6.6120 g | 6.6505 g | 6.6035 g | 6.6148 g |
| Total weight | 9.8330 g | 10.9100 g | 10.0880 g | 10.0730 g | 9.9100 g | 10.251 g |
| HAIP final loading | 0.4049% | 0.6035% | 2.4156% | 4.7589% | 2.3214% | 0.6254% |

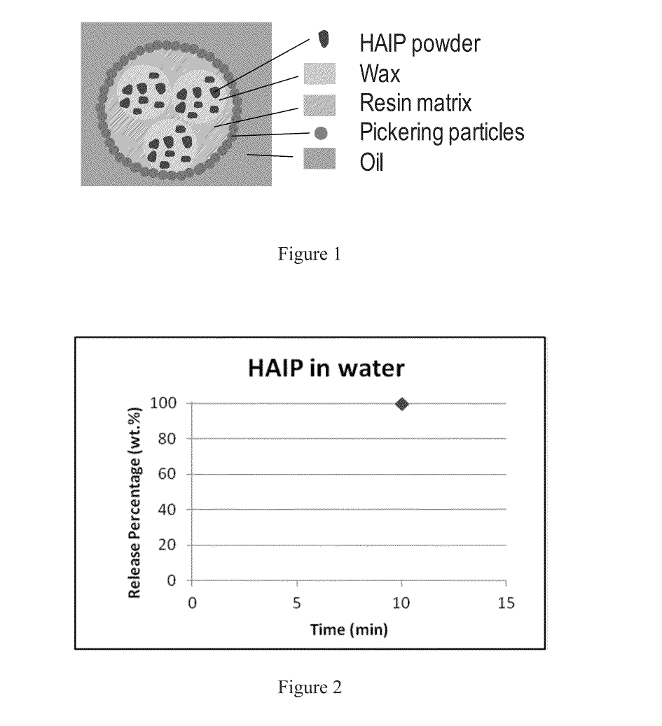

Control (HAIP powder): FIG. 2 shows the release profile of 1-MCP from HAIP powder upon contact with water. The 1-MCP gas is quickly and completely released from HAIP after approximately 10 minutes.

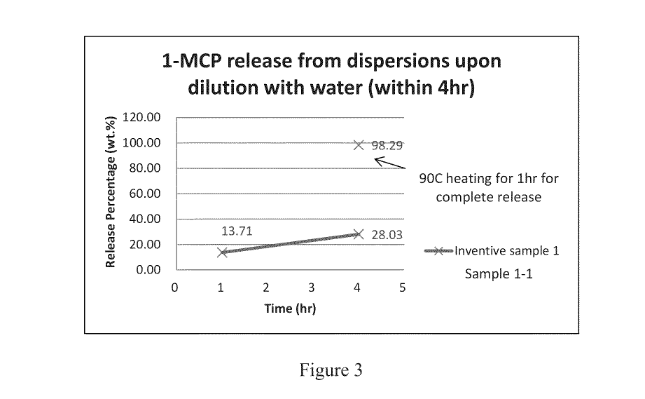

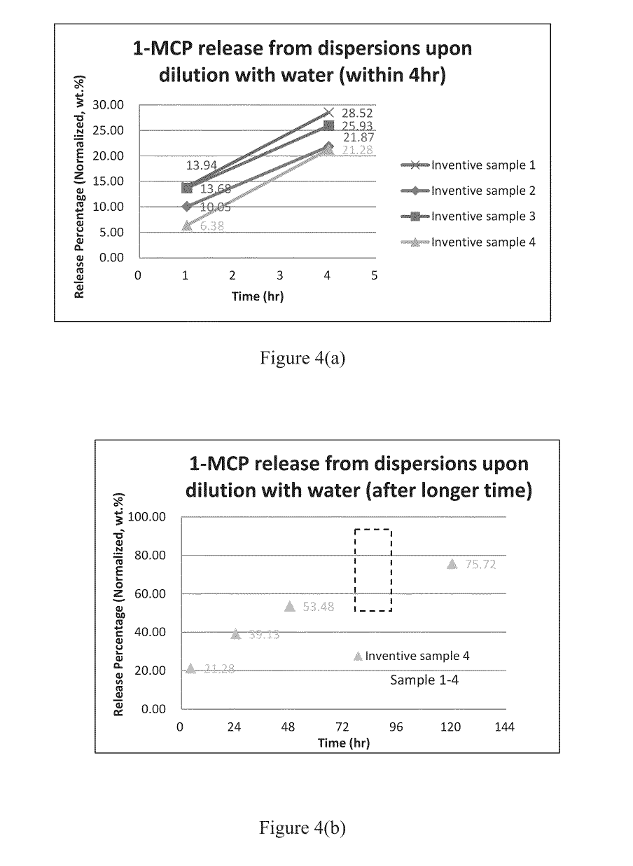

Samples 1-1 to 1-6 (HAIP dispersions): FIG. 3 shows a representative release profile of 1-MCP from the diluted Sample 1-1 (HAIP loading 0.4049%). After 1 hour, the release ratio is only ˜14%, which is much slower than the pure 1-MCP complex product (HAIP powder) (as compared to FIG. 2). After 4 hours, Sample 1-1 releases ˜28% of 1-MCP, suggesting that the encapsulated HAIP dispersion can delay the initial 1-MCP release. When Sample 1-1 is finally heated for 1 hour to a temperature above the melting point of carnauba wax, 90° C., the total amount of 1-MCP released can go up to ˜98%, which is closed to the expected theoretical value, suggesting that a minimal amount of 1-MCP is lost during the double encapsulation process. A more complete release rate curve can be determined based on the normalized release ratio at each time point (see FIG. 4a). This convenient way to compare the release rate profiles of different formulations is provided herein.

The amount of 1-MCP released is low in Samples 1-1 to 1-4 (between 6 to 14% within the first hour following contact with water). Samples 1-1 to 1-4 gradually release 1-MCP with a similar trend, reaching 21 to 29% of 1-MCP after 4 hours, demonstrating delayed release of 1-MCP for the formulation provided made with carnauba wax and/or polycaprolactone (PCL) as compared to uncoated HAIP powder.

FIG. 4b shows a representative release of 1-MCP for Sample 1-4 over an extended period of time up to several days after its initial contact with water. The graph shows that 75% 1-MCP is released over a period of 5 days.

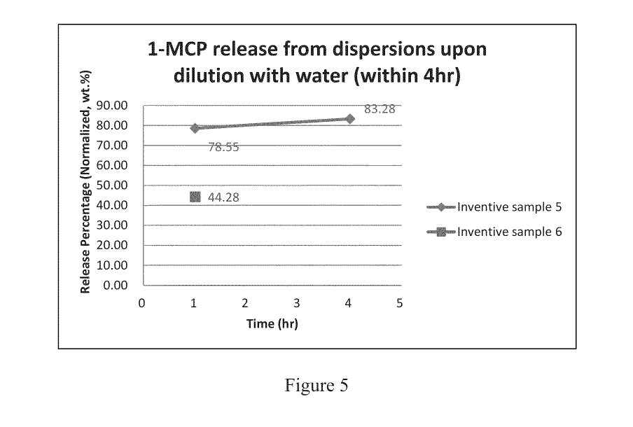

FIG. 5 shows the release profile of 1-MCP from Samples 1-5 and 1-6, 4 hours after dilution in water, demonstrating the use of candelilla wax (Sample 1-5) and/or stearic acid (Sample 1-6) as the core particle materials and PCL as the shell to enable delayed initial release of 1-MCP. A release of ˜79% and ˜44% is obtained 1 hour after the contact with water for Sample 1-5 and Sample 1-6, respectively.

In view of the above results, the double matrix encapsulation process of the present invention can be useful for spray tank applications. In this example, the HAIP particles are double-encapsulated by a wax core and a resin shell. The emulsification is done using a Pickering system. The designed structure brings significant improvement in delaying the initial 1-MCP release (˜25% after 4 hours in water) as compared with unprotected HAIP powder (-100% in 10 minutes). It is believed that water penetration is hindered as it goes through the successive layers of oil medium, hydrophobic particles, resin matrix and the wax to finally interact with HAIP and, in turn, releases 1-MCP. Accordingly, extended release of 1-MCP can be achieved for a formulation designed to be used in spray tanks containing water, and the formulations disclosed enable easy storage and transportation.

### Example 2

### Images of Samples

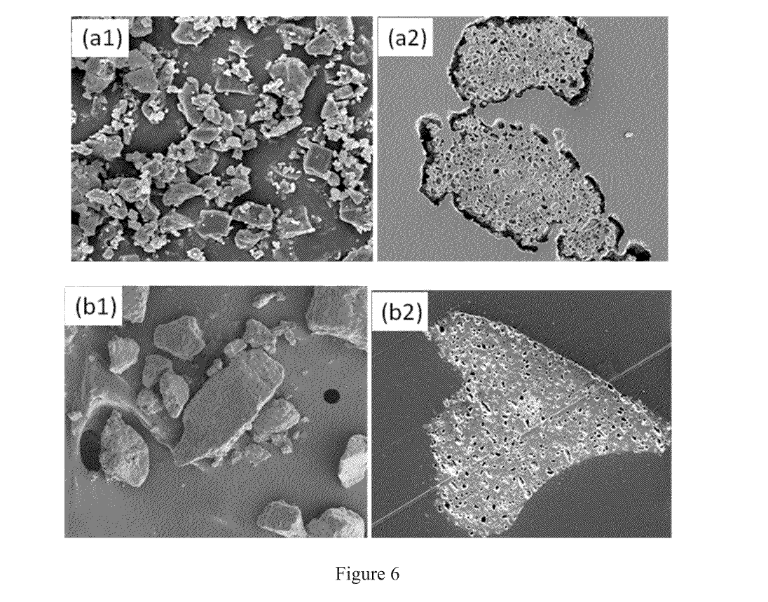

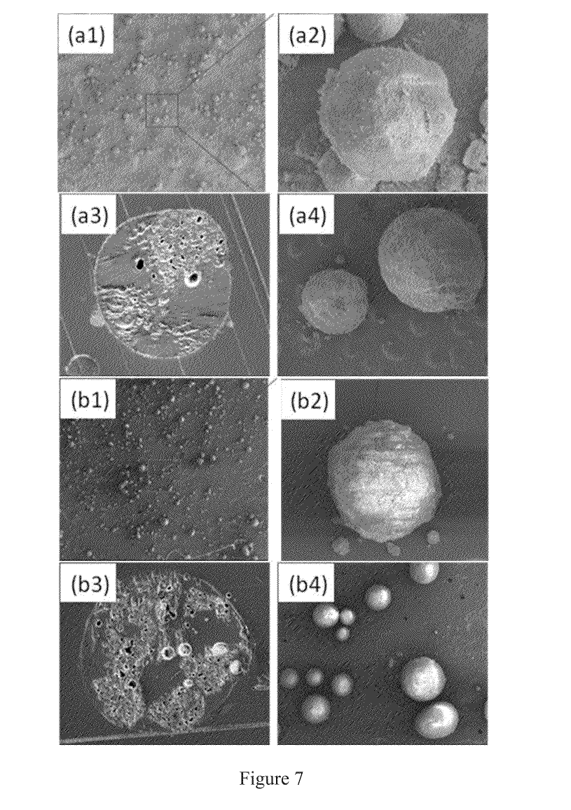

FIG. 6 shows SEM images of HAIP air milled product and HAIP-carnauba wax blended particles (after grinding and sieving through 100 mesh). Typically, the HAIP has 3-5 μm particle size, but some aggregates of larger particles can be observed (see arrows in FIG. 6a1, and FIG. 6a2). There are many uniform fine holes in the cross-section of HAIP particles, as shown in FIG. 6a2, which might be artifacts resulting from HAIP being dislodged during the sample cutting SEM preparation. The blend of HAIP and carnauba wax can be reduced in size by hand or by using a grinder thanks to the brittle nature of the wax. However, their particle size mainly remains constant between 100 and 200 mesh (75-150 μm), as shown in FIG. 6b1. The inner structure of the blended particles (FIG. 6b2) is similar with that of the HAIP (FIG. 6a2), indicating HAIP particles have been uniformly embedded in the wax matrix.

FIG. 7 shows SEM images of encapsulated particles from Sample 1-3 and 1-3. Following the PCL encapsulation based on Pickering emulsion, the resulting suspended particles are found to have a particle size around 20-100 microns (see FIGS. 7a1 and 7b1). All the particles are covered by hydrophobic silica nanoparticles (FIGS. 7a2 and 7b2). The cross-section morphology (FIGS. 7a3 and 7b3) is slightly different from the HAIP-wax blended particles (FIG. 6b2). In this last picture, the HAIP-wax blend is non-uniformly distributed in the PCL matrix particles, leaving some areas containing only the resin matrix. This resin distribution is consistent with the double encapsulated core-shell structure design described in FIG. 1, and such distribution is a key to the slow release of 1-MCP since water has to penetrate multi-layers of oil, coating and resin before being able to interact with HAIP. Note that some large particles with diameter in the order of hundred microns (FIGS. 7a4 and 7b4) are present in this formulation. This is due to the fact that the initial core HAIP-wax particles are somehow large (100 or 200 mesh) for this particular preparation.

1. A composition comprising a collection of double encapsulated particles suspended in an oil medium, wherein each of the double encapsulated particles comprises
(a) a resin matrix with a first melting point;
(b) a molecular complex coated in a waxy compound with a second melting point where the coated molecular complex is embedded in the resin matrix, and
(c) a coating comprising Pickering particles.

2. The composition of claim 1, wherein the molecular complex comprises a volatile compound and a molecular encapsulating agent.

3. The composition of claim 2, wherein the volatile compound comprises a cyclopropene.

4. The composition of claim 3, wherein the cyclopropene is of the formula: 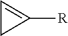
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

5-7. (canceled)

8. The composition of claim 3, wherein the cyclopropene comprises 1-methylcyclopropene (1-MCP).

9. The composition of claim 2, wherein the molecular encapsulating agent comprises alpha-cyclodextrin, beta-cyclodextrin, gamma-cyclodextrin, or combinations thereof.

10. The composition of claim 2, wherein the molecular encapsulating agent comprises alpha-cyclodextrin.

11. (canceled)

12. The composition of claim 1, wherein the resin matrix comprises polyester, polyether, epoxy resin, isocyanate, ethylene vinyl acetate copolymer, or combinations thereof.

13. The composition of claim 1, wherein the resin matrix comprises polycaprolactone polyols.

14. (canceled)

15. The composition of claim 1, wherein the first melting point is from 30° C. to 70° C.

16-17. (canceled)

18. The composition of claim 1, wherein the second melting point is from 75° C. to 120° C.

19-20. (canceled)

21. The composition of claim 1, wherein the Pickering particles comprise hydrophobic silica.

22. The composition of claim 21, wherein silica surface of the hydrophobic silica is modified by silane coupling agent or organosilicon.

23. The composition of claim 1, wherein the oil comprises a mixture of alkanes in the C15 to C40 range.

24. The composition of claim 1, wherein the ratio of the double encapsulated particles to the oil is from about 2:1 to about 1:100.

25. (canceled)

26. The composition of claim 1, wherein the ratio of the molecular complex to the waxy material is from about 1:1 to about 1:100, by weight.

27. (canceled)

28. The composition of claim 1, wherein the ratio of the molecular complex together with the waxy material to the resin is from about 1:1 to about 1:100, by weight.

29. (canceled)

30. The composition of claim 1, wherein the ratio of the Pickering particles to the oil is from about 1:5 to about 1:25, by weight.

31. (canceled)

32. The composition of claim 1, wherein the average particle size of the double encapsulated particles is from about 1 micron to about 200 microns.

33. (canceled)

34. The composition of claim 1, further comprising at least one surfactant.

35. A method for preparing a composition, comprising,
(a) blending a molecular complex with a waxy material at a temperature higher than melting point of the waxy material to provide a blend;
(b) melting a resin at a temperature higher than its melting point;
(c) mixing the blend of step (a) and melted resin of step (b) to provide an uniform molecular complex-waxy material-resin dispersion;
(d) mixing Pickering particles with an oil;
(e) dispersing the molecular complex-waxy material-resin dispersion of step (c) into the mixture of Pickering particles and oil of step (d); and
(f) allowing solidification of the composition at a temperature lower than the melting temperature of the resin.

36-38. (canceled)

39. The method of claim 35, wherein the solidification does not comprise curing.

40. The method of claim 35, wherein the oil comprises a mixture of alkanes of C15 to C40, or a distillate of petroleum.

41-46. (canceled)

47. The method of claim 35, wherein the molecular complex comprises a cyclopropene and a molecular encapsulating agent.

48-51. (canceled)

52. The method of claim 47, wherein the cyclopropene comprises 1-methylcyclopropene (1-MCP).

53. (canceled)

54. The method of claim 47, wherein the molecular encapsulating agent comprises alpha-cyclodextrin.

55-58. (canceled)

59. The method of claim 35, wherein the resin comprises a polycaprolactone polyol having a melting point from about 50° C. to about 60° C.

60-61. (canceled)

62. An emulsion comprising:
(a) an aqueous medium; and
(b) a composition in accordance with claim 1.

63. A sprayable slow-release formulation comprising the emulsion of claim 62.

64. A method of treating plants or plant parts comprising contacting said plants or plant parts with an emulsion in accordance with claim 62.
